(19) United States
(12) Patent Application Publication
(10) Pub. No.: US 2015/0378039 A1
(43) Pub. Date: Dec. 31, 2015

(54) SYSTEM AND METHOD FOR SEISMIC IMAGING OF A COMPLEX SUBSURFACE

(71) Applicants: Yonghe J. Sun, Cypress, TX (US); Yue Wang, Sugar Land, TX (US)

(72) Inventors: Yonghe J. Sun, Cypress, TX (US); Yue Wang, Sugar Land, TX (US)

(73) Assignee: CHEVRON U.S.A. INC., San Ramon, CA (US)

(21) Appl. No.: 14/317,331

(22) Filed: Jun. 27, 2014

(51) Int. Cl. G01V 1/28; G01V 1/30

(52) U.S. Cl. CPC G01V 1/282; G01V 1/303

(57) ABSTRACT

Seismic data may be processed to improve a geologic model of a subsurface volume of interest by receiving an initial geologic model, generating a γ-parameter family of models by perturbing parameters of an initial geologic model, migrating the seismic data using each of the models in the γ-parameter family of models to generate a set of migration images, constructing a γ-volume by scanning the set of migration images wherein each location in the γ-volume is assigned a value representing a preference of one of the migration images; and inverting the γ-volume.

### FIELD OF THE INVENTION

The present invention relates generally to methods and systems for processing seismic data and, in particular, methods and systems for updating imaging parameters in areas of complex subsurface such as below salt bodies.

### BACKGROUND OF THE INVENTION

In the field of exploration geophysics, seismic data is typically recorded through the use of active seismic sources; such as air guns, vibrator units, or explosives; and receivers; such as hydrophones or geophones. The sources and receivers may be arranged in many configurations. Typically, a seismic survey is designed to optimize the source and receiver configurations so that the recorded seismic data may be processed to locate and/or analyze subsurface geological features of interest such as hydrocarbon reservoirs.

In many areas, hydrocarbon reservoirs are found near or below complex geologic structures such as salt bodies. Such structures may have rugose boundaries and large velocity contrasts across those boundaries. This results in poor and non-uniform illumination of the subsurface volume near and below the complex structures. Consequently, seismic data representative of the subsurface may be low quality and plagued with noise such as multiples.

Poor seismic data quality is a major problem in seismic imaging. Proper seismic imaging often requires reasonably accurate estimates of the subsurface velocities, which are commonly determined using some type of tomography (e.g. reflection tomography). Many conventional tomography techniques estimate subsurface velocities based on moveout analysis of common-image-point gathers (e.g. common-reflection-point gathers, common-depth-point gathers). Such analysis is difficult or impossible to do in areas where poor illumination has resulted in missing data or low signal-to-noise ratio and where the residual moveouts identified in the tomography process may not necessarily indicate velocity errors.

Seismic imaging may also be impacted by other factors besides subsurface velocity estimation. Many parameters related to anisotropy and attenuation, among others, can impact seismic imaging. These parameters may also be poorly estimated in areas of complex subsurface.

There is a need for seismic processing methods that can improve estimation of parameters such as, by way of example and not limitation, subsurface velocities, anisotropy parameters, and attenuation, thereby improving the seismic imaging and ultimately the geological model of the subsurface so that hydrocarbon reservoirs may be identified and produced in an efficient and economical way.

### SUMMARY OF THE INVENTION

Described herein are implementations of various approaches for a computer-implemented method for seismic imaging of a subsurface volume of interest.

A computer-implemented method; including generating a γ-parameter family of models by perturbing the parameters of an initial geologic model a plurality of times to create one new model each time, wherein the new model becomes a member of the γ-parameter family of models; performing a plurality of seismic migrations of a seismic dataset, wherein the seismic migrations are all of a same type and wherein one seismic migration is performed for each of the models in the γ-parameter family of models, to generate a set of migration images; constructing a γ-volume by scanning the set of migration images wherein each location in the γ-volume is assigned a value representing a preference of one of the migration images; and inverting the γ-volume to obtain an improved geologic model of the subsurface volume of interest; is disclosed. The method may also include using the improved geologic model for further seismic imaging and identifying hydrocarbon reservoirs. The method may be used for interpretative seismic imaging and model updating. The method may be useful for subsalt imaging.

In another embodiment, a computer system; including a data source or storage device, at least one computer processor, and a user interface used to implement the method for seismic imaging of a subsurface volume of interest; is disclosed.

In yet another embodiment, an article of manufacture including a non-transitory computer readable medium having computer readable code on it, the computer readable code being configured to implement a method for seismic imaging of a subsurface volume of interest, is disclosed.

The above summary section is provided to introduce a selection of concepts in simplified forms that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims, and accompanying drawings where:

FIG. 1 is a flowchart of an embodiment of the present invention; and

FIG. 2 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to processing seismic data in order to improve the geological model of a subsurface volume of interest, thereby allowing improved seismic imaging and interpretation of the subsurface. One of the benefits of the present invention is its generality. For example, the present invention can be used to improve estimates of any imaging-sensitive parameters, including, by way of example and not limitation, velocity parameters, anisotropic parameters, attenuation parameters, and symmetry axes. In addition, the present invention is also valid for use with a variety of migration/imaging algorithms such as Kirchhoff migration, Gaussian beam migration, or reverse time migration, as well as others of which one skilled in the art will be aware. These are just two examples of the generality of the present invention; more will become apparent during the detailed description below.

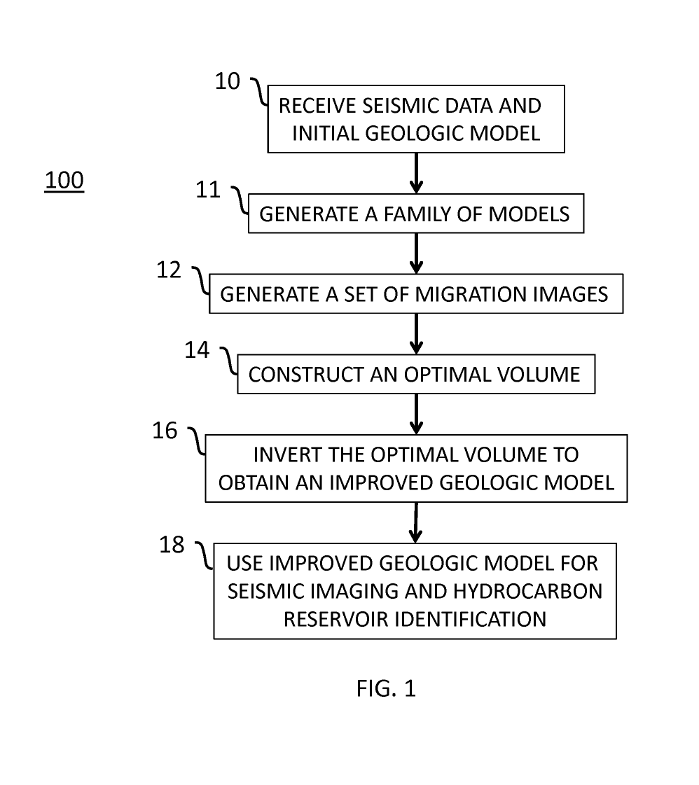

One embodiment of the present invention is shown as method 100 in FIG. 1. At operation 10, the seismic data and an initial geologic model are received. The seismic data may be recorded seismic data or synthetic seismic data. The initial geologic model will include at least a velocity parameter for a plurality of subsurface locations. In addition, the geologic model may include other parameters such as, but not limited to, anisotropy parameters, symmetry axis parameters, and attenuation parameters. At operation 11, the parameters of the geologic model are perturbed to make a new model; this is done several times so that each new model may be added to a γ-parameter family of models.

Let m⁽⁰⁾(x) be an initial and imperfect imaging model and Δm⁽⁰⁾(x) be a (usually small) perturbation from m⁽⁰⁾(x), where x=(x,y,z) is a position vector variable in the 3D subsurface. Define a γ-parameter family of models m(x;γ):

m(x;γ)=m⁽⁰⁾(x)+γΔm⁽⁰⁾(x). (1)

The range and magnitude of γ is somewhat arbitrary, subject to an arbitrary scale factor for Δm⁽⁰⁾(x). Alternatively, one can define a continuous γ-parameter family of models m(x;γ) using two models m⁽⁰⁾(x) and m(¹)(x)

m(x;γ)=(1-γ) m⁽⁰⁾(x)+γm(¹)(x). (2)

Equation (1) is a special case of equation (2) with an expanded γ range and Δm⁽⁰⁾(x)=m(¹)(x)−m⁽⁰⁾(x). More generally, one can define a continuous γ-parameter family of models m(x;γ) using a list of M existing models m(^{j})(x), corresponding to a monotonic set of parameters γ(^{j}), j=1, 2, . . . , M values by interpolation. For example, using Lagrange interpolation,

m(x;γ)=Σⱼ{Π_{i≠j}[γ−γ⁽ⁱ⁾]}/{Π_{i≠j}[γ^{(j)}−γ^{(i)]}}m⁽j)(x) (3)

where the range of γ depends on the values chosen for the γ^{(j)}s. Equations (1) and (2) are special cases of equation (3) with M=2, γ⁽⁰⁾⁼0 and γ(¹)=1. Embodiments using any or all three of these equations are included in the scope of the present invention.

Once a γ-parameter family of models has been generated, each of the models in the family can be used to create a set of migration images at operation 12. In this operation, the seismic data is migrated several times, each time using one of the models in the γ-parameter family of models, and each time using the same migration algorithm (e.g. Kirchhoff, Gaussian Beam, reverse time migration). This will generate a set of migration images I(y;γᵢ) created for a discrete set of γᵢ, i=1, 2, . . . , N values, where y is a vector variable indexing the image positions. For post-stack time migrations, the images are in time domain so y=(x,y,t). For depth migrations, y=(x,y,z; a), or y=(x,y,t; a) if the images have been converted from depth to time. Here the variable a is used to indicate that the image can be prestack gathers with a referring to, for example, the vector-valued source-receiver offset or reflection angle and azimuth. The depth-to-time conversions of I(y;γᵢ) uses the migration model m(x;γᵢ). The time domain has the advantage that, for velocity models that are slowly varying laterally, the positions of the images I(y;γᵢ) generally do not shift much in time t, but can shift rapidly in depth z as y varies if the model changes correspond to changes in migration velocity. Each of the generated set of migration images will have some slight differences such as focusing, moveout, reflector structure and/or location, and the like.

At operation 14, an optimal γ-volume is constructed from the set of migration images. It can be constructed based on any criteria desired by the user. The user need not select the best image for each individual location in the volume but can select representative gathers, sections, areas, etc. Image scanning can be used to search for a better model m(x), when the existing models m(^{j})(x) are not good enough for imaging. An interpreter can find a γⱼ at each image location y so I(y;γⱼ) is the best among all the images I(y;γᵢ), i=1, 2, . . . , N The outcome of this interpretation procedure is a γ(y) volume, the optimal index γ for a set of image locations y. The criteria for optimality are entirely up to the interpreter who finds one image best among all scanned images at y. By way of example and not limitation, the criteria might be improved focusing of diffractors, sharpness of image, flatness of common image point (CIP) gathers, positioning of reflectors, simplicity of structure, or plausibility of geology. In practice, the interpreter can only pick a discrete subset of points in the image space (e.g., at a grid of x, y, and t positions) and γ(y) may span only a subspace of the image dimensions of y (e.g., x, y, t, but not a, when the interpreter picks images with the smallest residual curvature that measures residual moveout with respect to a). This process creates the optimal volume γ(y) of the scanning parameter γ.

The optimal γ-volume is inverted at operation 16 to obtain an improved geologic model. This inversion may be tomography. Tomography can produce a new model vector m(x). Let

d(y)=F(m(x)) (4)

represent the forward modeling used in a tomography process, where d(y) is the data vector. In particular, we have

d(^{j})(y)=F(m(^{j})(x)), j=1,2, . . . ,M. (5)

The task of the tomography is to reverse the process: given data vector d(y), find the model vector m(x):

m(x)=F⁻¹(d(y)) (6)

Referring again to FIG. 1, operation 16 seeks to find the model m(x), given the implementations for both forward modeling operator F and tomographic inversion operator F⁻¹, and given the optimal volume γ(y). This may be done by linking the optimal volume γ(y) to the optimal data vector d(y), the input data to tomography in equation (6). A natural approach for such a link uses the same relationship (3) that interpolates the models m^{(j)}(x) to interpolate the forward modeled data d(^{j})(y):

d(y;γ)=Σⱼ{Π_{i≠j}[γ−γ⁽ⁱ⁾]}/{Π_{i≠j}[γ^{(j)}−γ^{(i)]}}d^{(j)}(y) (7)

Using the data identified by optimal volume γ(y) in equation (7) to obtain the input data for tomography in equation (6), the updated model vector is:

m_{new}(x)=F⁻¹(d(y, γ(y))), (8)

thereby generating the improved geologic model m_{new}(x). Note that although tomography is generally and typically used to invert for velocity, in the present invention the forward modeling operator F and tomographic inversion operator F⁻¹ need not only include velocity but can be used to account for any combination of wave-propagation and imaging sensitive parameter types. In addition, the forward modeling operator may use raytracing or wave-equation based modeling methods. The inversion operator may use vertical 1-D updates, 3-D raytracing tomography, or full-waveform inversion. The model vectors m(x) and m_{new}(x) can be region-based, gridded, or otherwise parameterized. The data d(y) can be residual moveout picks of common-image-point gathers in migration velocity analysis, traveltime residuals in traveltime inversion, waveform residuals in waveform inversion, or other forms of application-dependent measures of differences between modeled data and measured data.

The improved geologic model can be used for seismic imaging at operation 18. The seismic imaging may be migration, using the same or a different algorithm as used in operation 12. The seismic image produced by this operation may be better than a seismic image produced using the initial geologic model.

As previously explained, the method of the present invention is designed to be highly flexible, including generality in:

A. The model representation. The above procedure places no restrictions on model representation. It neither restricts nor depends on how the existing models m^{(j)}(x), j=1,2, . . . ,M are different from each other. The differences can be in velocity, anisotropic parameters, attenuation parameters, symmetry axes, or any other imaging-sensitive model attributes. The approach does not prescribe how the monotonic set of γ(^{j}), j=1, 2, . . . , M values are chosen and what their ranges are.

B. The optimality criteria used to generate the optimal volume. The criteria for optimality can be based on improvement in focusing of diffractors, sharpness of image, flatness of CIP gathers, positioning of reflectors, simplicity of structure, plausibility of geology, or any other desirable features that users deem best in one image among all scanned images.

C. The imaging algorithm. One can use Kirchhoff, Gaussian beam, reverse-time, or other migration/imaging algorithms.

D. The implementation/approximation of the forward modeling operator F used in tomography. In particular one can use raytracing or wave-equation based modeling methods.

E. The implementation/approximation of tomographic inversion operator F⁻¹. For example, one can use vertical 1D updates, 3D ray tracing tomography, or full-waveform inversion.

F. The representations of the model vector m(x) and data vector d(y). For example, the model can be region-based, gridded, or otherwise parameterized; and the data can be residual curvature picks, waveform residual data, or other forms of measurements of the differences between modeled and measured data.

Any specialization or combination of the special treatments of these generalities leads to distinct use cases. Some of these special cases allow further algorithm or workflow optimizations. By way of example and not limitation, the general approach may be tailored to the following embodiments (use cases):

Use Case 1: One imperfect initial geologic model m⁽⁰⁾(x) and a perturbation Δm(x) from m⁽⁰⁾(x). The perturbation can be computed by taking the difference between m^{(j)}(x) and another model m⁽¹⁾(x). The γ-parameter family of models m(x;γ) is

m(x;γ)=m⁽⁰⁾(x)+γ·Δm⁽⁰⁾(x) (9)

where −1≦γ≦1. We assume that the Δm⁽⁰⁾(x) is small in the sense that the perturbation in the kinematics used for imaging is small enough so interpreters can still make identification of corresponding events in both the initial image I(y;0) and the family of perturbed images I(y;γᵢ) created for a discrete set of scan values γᵢ, i=1, 2, . . . , N Migration scanning for migration velocity analysis has been traditionally applied to just velocity. The present invention can be used to scan many different types of model parameters (e.g., velocity, anisotropy parameters, anisotropy symmetry axes, source wavelet, statics, etc.), and combinations thereof, to which imaging is sensitive. This generality is available in the present invention because the link between the inversion input data d(y;γ(y)) and optimal volume of picks γ(y) through interpolation and the forward modeling operators F does not require additional explicit relationships or equations that may be difficult to specify.

Use Case 2: A special case of Use Case 1 with linearization of the forward modeling and inversion operator. Small perturbations around the initial model m⁽⁰⁾(x) sometimes allows linearization of imaging operator I, forward modeling operator F, and/or inversion operator F⁻¹. As a non-limiting example, using the linearization d(y)=F(m(x)), we have

Δd⁽⁰⁾(y)=L(m⁽⁰⁾(x))·Δm⁽⁰⁾(x) (10)

where the linearized modeling operator L=∇ₘF (m⁽⁰⁾(x)) only depends on the initial geologic model m⁽⁰⁾(x) and ∇m is the gradient operator with respect to the model vector m. The mapping from the “γ picking” is trivial:

Δd(y;γ)=γΔd⁽⁰⁾(y) (11)

and the updated model m(x) is obtained by tomography that implements or approximates

m(x)=m⁽⁰⁾(x)+L⁻¹·γ(y) Δd⁽⁰⁾(y) (12)

In kinematic modeling, Δd(y) often corresponds to a measure of the depth residual moveout picks in the common-image-point (CIP) gathers or traveltimes. The tomographic inversion operator L⁻¹ can be implemented, for example, by gradient-based iterative optimization with raytracing or wave-equation based forward modeling. The novelty of this use case is represented by equations (10) and (11), where the γ-picks are mapped to tomographic input data γ(y) Δd⁽⁰⁾(y) in equation (12) with a single forward modeling operation in equation (10).

Use Case 3: Interpretive imaging and model updating within geobodies of fixed geometric shapes. This use case can be represented by two existing models m⁽⁰⁾(x) and m(¹)(x) with identical parameterization and geobody geometries but different parameter values within the geobodies and with M=2, γ⁽⁰⁾=0 and γ⁽¹⁾−1. Geobody scanning can be helpful for building anomalies with high contrasts above the background values and for testing out a continuous spectrum of scenarios. Examples of scanned parameters include, but are not limited to, velocity, attenuation parameter Q, symmetry axes of orthorhombic anisotropy. Examples of geobodies include, but are not limited to, salt bodies with high salt-sediment velocity contrast and gas pockets with anomalously strong attenuation.

Use Case 4: Interpretive imaging and model updating with deformation of geobodies. This case can be represented by a large number of models M>>2, N=M, γᵢ=γ¹, i=1, 2, . . . ,N. These N models will capture a monotonic sequence of deformations. The scanning is used to define the shapes of the geobodies or geologic boundaries.

Use Case 5: Subsalt model parameter scanning. This can be viewed as a special case of Use Cases 1, 2, or 3. Subsalt is challenging because of the high sediment-salt contrasts. Overburden velocity above a reference surface below salt can be assumed known. Sophisticated wave propagation methods can be used to redatum the recorded wave fields to the reference surface. Simplifying assumptions, such as the high frequency approximation, can then be made about wave propagation below the reference surface if the subsalt model is simple.

These use cases are embodiments that are not meant to be limiting. They illustrate the varied uses and overall generality of the present invention. Those skilled in the art will appreciate that there are many other possible uses that may be conceived of within the scope of the present invention.

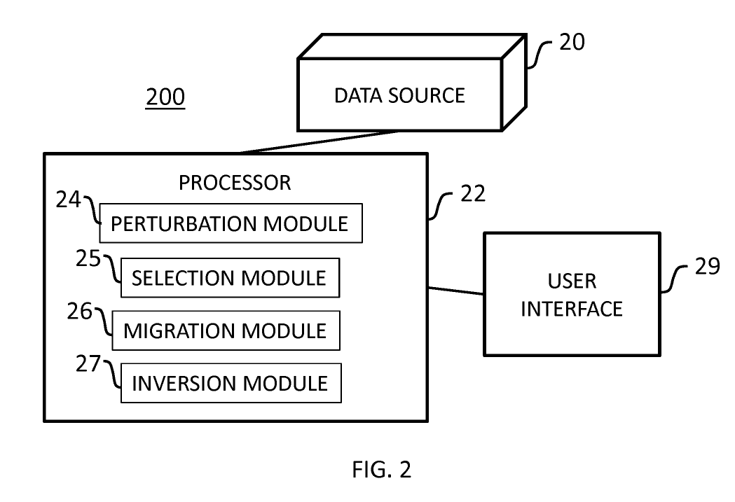

A system 200 for performing the method 100 of FIG. 1 is schematically illustrated in FIG. 2. The system includes a data source/storage device 20 which may include, among others, a data storage device or computer memory. The data source/storage device 20 may contain recorded (measured) seismic data or synthetic (modeled) seismic data. The data from data source/storage device 20 may be made available to a processor 22, such as a programmable general purpose computer. The processor 22 is configured to execute computer modules that implement method 100. These computer modules may include a perturbation module 24 for generating a γ-parameter family of models, a selection module 25 for constructing an optimal γ-volume, a migration module 26 for migrating the seismic data using the family of models or the improved geologic model, and an inversion module 27 for inverting the optimal volume to an improved geologic model. These modules may include other functionality. In addition, other modules such as an interpretation module to interpret the seismic images or geologic models may be used. The system may include interface components such as user interface 29. The user interface 29 may be used both to display data and processed data products and to allow the user to select among options for implementing aspects of the method. By way of example and not limitation, the input seismic data and/or the improved geologic model computed on the processor 22 may be displayed on the user interface 29, stored on the data storage device or memory 20, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for processing seismic data, the method comprising:
a. receiving, at a computer processor, a seismic dataset representative of a subsurface volume of interest and an initial geologic model of the subsurface volume of interest wherein the initial geologic model includes two or more types of parameters including velocity parameters, anisotropy parameters, or attenuation parameters;
b. generating, via the computer processor, a γ-parameter family of models by perturbing the parameters of the initial geologic model a plurality of times to create one new model each time, wherein the new model becomes a member of the γ-parameter family of models;
c. performing, via the computer processor, a plurality of seismic migrations of the seismic dataset, wherein the seismic migrations are all of a same type and wherein one seismic migration is performed for each of the models in the γ-parameter family of models, to generate a set of migration images;
d. constructing a γ-volume by scanning the set of migration images wherein each location in the γ-volume is assigned a value representing a preference of one of the migration images; and
e. inverting, via the computer processor, the y-volume to obtain an improved geologic model of the subsurface volume of interest.

2) The method of claim 1 further comprising using the improved geological model for a separate seismic imaging process to get an improved seismic image.

3) The method of claim 1 further comprising identifying a hydrocarbon reservoir based on the improved geological model.

4) The method of claim 1 wherein the value selected from one of the migration images to construct the γ-volume is selected based on user-defined optimality criteria.

5) The method of claim 1 used for interpretative seismic imaging and model updating.

6) The method of claim 1 used for subsalt imaging.

7) A system for processing seismic data, the system comprising:
a. a data source containing a seismic dataset and an initial geological model of representative of the subsurface volume of interest;
b. a computer processor configured to execute computer modules, the computer modules comprising:
i. a perturbation module for generating a γ-parameter family of models;
ii. a selection module for constructing a γ-volume;
iii. a seismic migration module; and
iv. an inversion module for inverting the γ-volume to obtain an improved geologic model of the subsurface volume of interest; and
c. an user interface.

8) An article of manufacture including a non-transitory computer readable medium having computer readable code on it, the computer readable code being configured to implement a method for processing seismic data, the method comprising:
a. generating a γ-parameter family of models by perturbing parameters of an initial geologic model of a subsurface volume of interest a plurality of times to create one new model each time, wherein the new model becomes a member of a γ-parameter family of models;
b. performing a plurality of seismic migrations of a seismic dataset, wherein the seismic migrations are all of a same type and wherein one seismic migration is performed for each of the models in the γ-parameter family of models, to generate a set of migration images;
c. constructing a γ-volume by scanning the set of migration images wherein each location in the γ-volume is assigned a value representing a preference of one of the migration images; and
d. inverting the γ-volume to obtain an improved geologic model of the subsurface volume of interest.
